(19) United States
(12) Patent Application Publication
(10) Pub. No.: US 2005/0252075 A1
(43) Pub. Date: Nov. 17, 2005

(54) Wave shaped screen for insect trap

(75) Inventors: Richard E. Achor, Clemmons, NC (US); Richard E. Belmont, Winston-Salem, NC (US); Robert Zajeski JR., Homer Glen, IL (US)

Correspondence Address: GREER, BURNS & CRAIN, 300 S WACKER DR, 25TH FLOOR, CHICAGO, IL, 60606, US

(73) Assignee: Blue Rhino Global Sourcing, LLC

(21) Appl. No.: 10/842,867

(22) Filed: May 11, 2004

(51) Int. Cl. A01M 1/06

(52) U.S. Cl. 43/139

(57) ABSTRACT

An insect trap apparatus includes a trap housing having at least one inlet and at least one outlet. A source of suction is located within the housing and is in fluid communication with the inlet for drawing insects through the inlet. Insects are caught in a trap cup that is in fluid communication with the inlet. The trap cup has a screen having at least one crest and at least one trough.

### BACKGROUND OF THE INVENTION

This invention relates to an insect trap apparatus that uses suction to draw insects into the trap. More specifically, this invention relates to an improved trap cup to be used in such an insect trap apparatus.

Suction-type insect traps are well known in the art. Effective prior art suction traps use heat, water vapor, chemical attractants and combinations thereof to lure insects to the trap apparatus. In operation, an outlet stream containing the various attractants is released from the apparatus, attracting insects to the vicinity of the apparatus. When the insects get within a capture zone, a fan or other suction source draws large amounts of air and the insects entrained therein into a trap inlet. The insects are filtered from the air before it exits through an outlet. After the insects are collected within the insect trap, they are dehydrated, killed or stored until removal.

Some insect traps utilizing a sieve or filter, such as a trap cup or a net, face several design problems. First, there is limited space in which to deposit and hold the insects. Consumers are not only bothered with frequently emptying the trap, but they may doubt the efficacy of the trap if only a few insects fall from the trap cup when it is emptied. As the insects accumulate in the trap cup, the surface area for allowing the air through the cup decreases. The entire floor of the cup is blocked when a monolayer of insects is collected. To gather a large number of insects before the trap cup is emptied, the trap cup needs to have porous sidewalls and should be fairly deep to allow air passage through the sidewalls of the trap cup.

Second, as the surface area becomes blocked with insects, less surface area is available for air flow through the trap cup. When the trap cup becomes filled with of insects, airflow through the insect trap apparatus is stifled. Although the fan continues to circulate air, power is wasted recirculating the air within the trap, rather than pushing it through the trap cup. If the fan motor has no thermal protection, it will eventually overheat from heat build-up in the recirculating air and could burn out. More likely, a heat sensor will shut the fan off before it overheats. In either case, the immediate result is that the fan stops working and the trap cup must be emptied before the trap again becomes operational.

The resultant block in airflow not only increases motor temperature, but reduces airflow as the available work from the fan converts from flow to pressure to overcome the added resistance. This reduction in airflow reduces the suction, lessening the effectiveness of the trap.

Third, the insect trap is often positioned inside, at or near the bottom of the housing, making viewing or emptying the trap inconvenient for the user. Some traps require the user to perform multiple steps, including shutting down the unit, before they can even check the level of insects in the trap. The trap must be shut down, the housing must be opened, a mesh bag removed, emptied and replaced, the housing closed and the trap restarted to empty the trap of mosquitoes.

Thus, there is a need in the art for a trap cup in an insect trap apparatus that is convenient for the user to empty and can hold a large capacity of insects without blocking the airflow through the trap.

### SUMMARY OF THE INVENTION

The present insect trap apparatus features an improved trap cup. Emptying insects from the unit is easy and convenient for the user since the trap is located exterior to the housing and is easily positioned. Additionally, the trap cup has a large capacity for insects while maintaining good airflow.

More specifically, the present trap cup includes a wave-shaped screen having at least one trough and at least one crest. Preferably the wave is in the screen at the bottom of the trap cup, where insects collect in the one or more troughs and air flows freely through the one or more crests of the wave.

Additionally, the present trap apparatus includes a trap housing having at least one inlet and at least one outlet. A source of suction is associated with the housing and is in fluid communication with the inlet for drawing air and insects through the inlet. Insects are caught in the wave screen that is associated with the housing and in fluid communication with the inlet.

Improved airflow through the present insect trap overcomes many of the disadvantages of the prior art. The airflow can be directed through the trap so that insects can be separated in a location where they are conveniently accessed by the user for disposal. Versatility in air flow also allows receptacles for supplemental chemical attractants to be conveniently placed in areas where there is space for multiple receptacles to accommodate a variety of attractant sizes or types.

Use of the present wave screen makes efficient use of vertical space for both insect storage and airflow. Without making the trap cup larger, the effective surface area is increased considerably. As they are trapped, insects are mounded in the troughs of the wave and take up less surface area than if they were allowed to scatter over a flat surface. Protrusion of the crests above the mounds of insects provides surface for airflow in addition to that available through the sidewall.

The present wave screen is also partially self-cleaning and requires emptying less frequently than a conventional flat screen. Constant flow of air through the trap cup dehydrates and decomposes the insects caught in the trap cup. As the collected insect remains form mounds in the wave troughs, the weight of the collection of insects crushes those at the bottom of the mound, allowing the small pieces to fall through the screen and blow away in the breeze or drop unnoticeably into the grass.

Collection of insects in the trough of the wave provides reassurance to the user that the trap is operating properly. Where many insects are scattered over a large surface area, it may appear to the consumer that few insects are being caught by the trap. This perception may cause the user to be concerned that the trap is not operating correctly or that the trap is ineffective in catching insects. Concentration of the same number of insects in a smaller space makes it appear that significant numbers of insects have been captured, assuring the consumer that the trap is operating effectively.

The structure of the present insect trap also makes it more economical to manufacture. Conduits for fluid transfer are molded into other structural elements, providing fewer parts that need to be molded, stored and assembled. Less manufacturing and assembly labor can be used, since fewer parts are made and assembled. The cost of making the molds is reduced. Thus, the present insect trap can be more efficiently made than other popular suction traps, resulting in savings to both the manufacturer and the consumer.

### DETAILED DESCRIPTION OF THE DRAWINGS

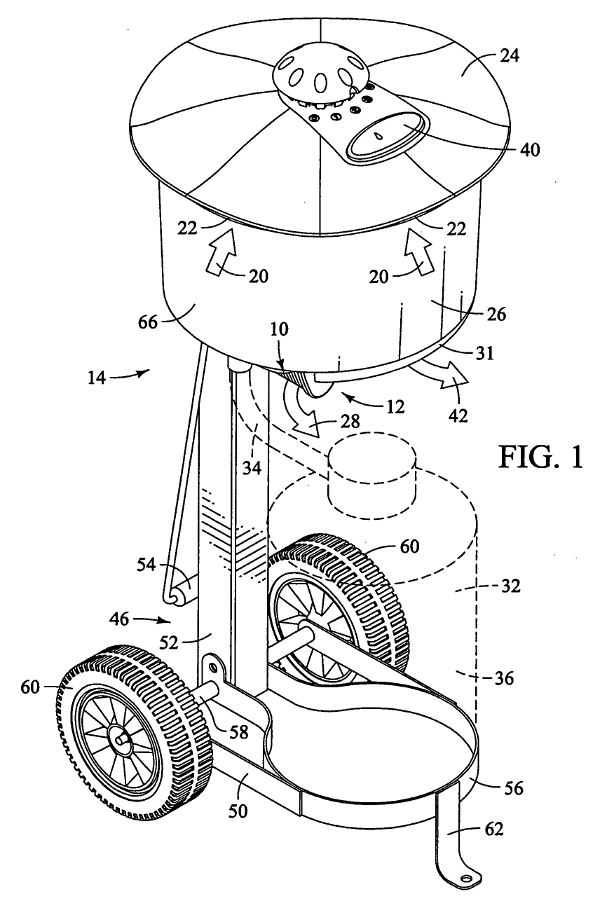

FIG. 1 is a perspective view of one embodiment of the present insect trap mounted to a cart;

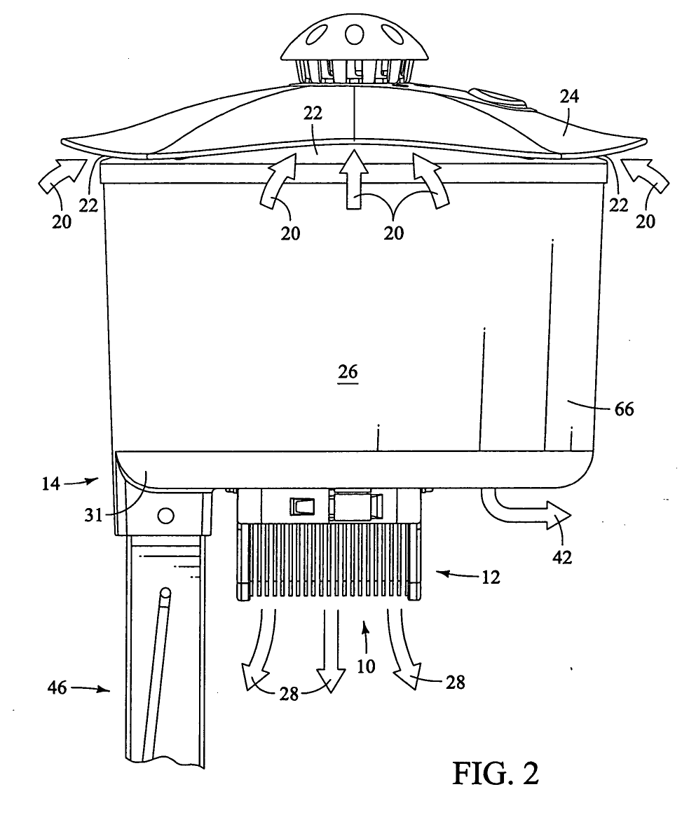

FIG. 2 is a fragmentary side plan view of the trap head and trap cup;

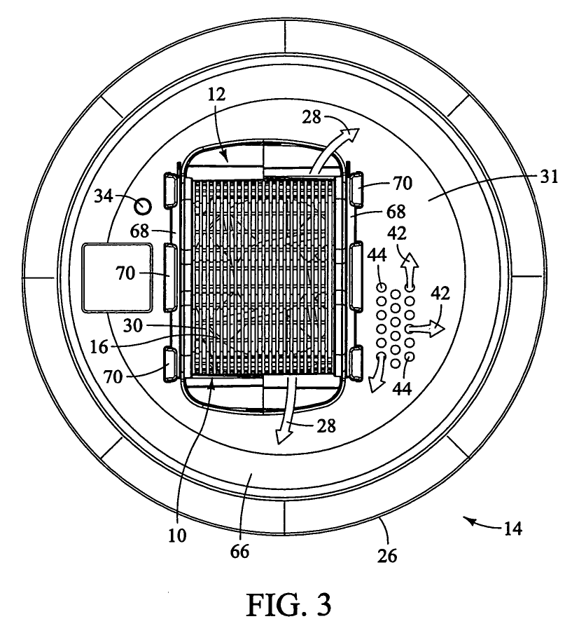

FIG. 3 is a bottom plan view thereof;

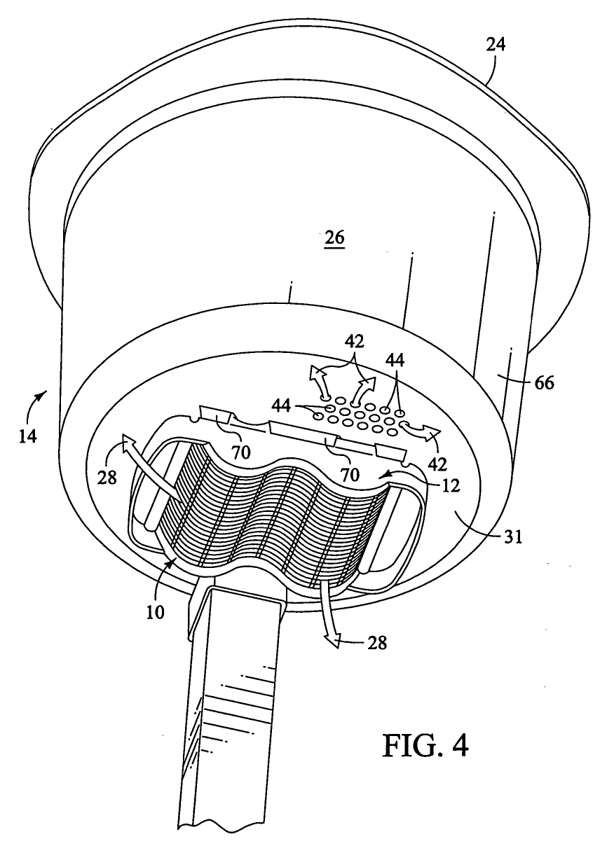

FIG. 4 is a fragmentary bottom perspective view thereof;

FIG. 5 is a bottom perspective view of the trap cup and wave screen;

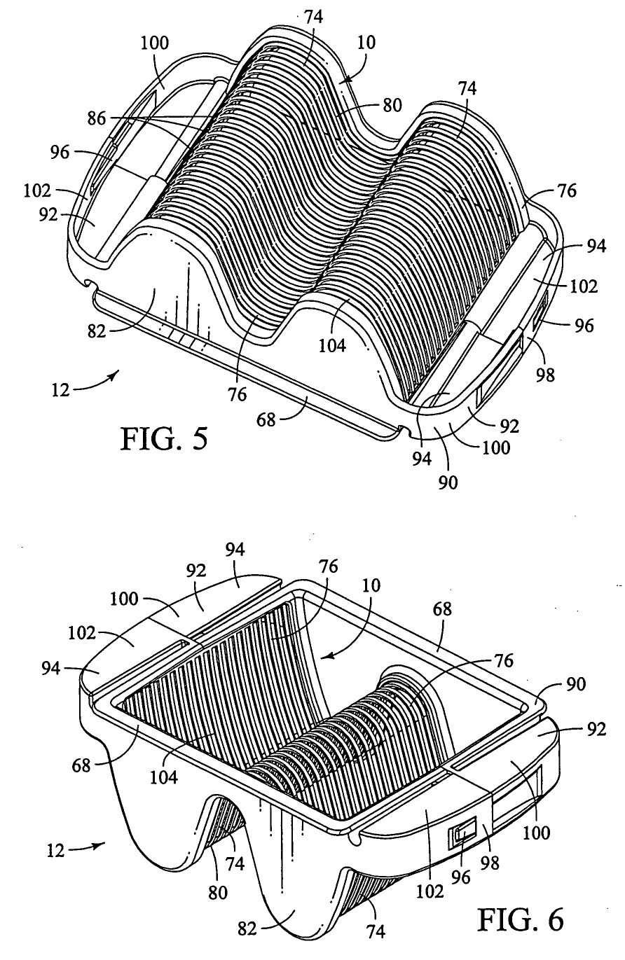

FIG. 6 is a top perspective view thereof;

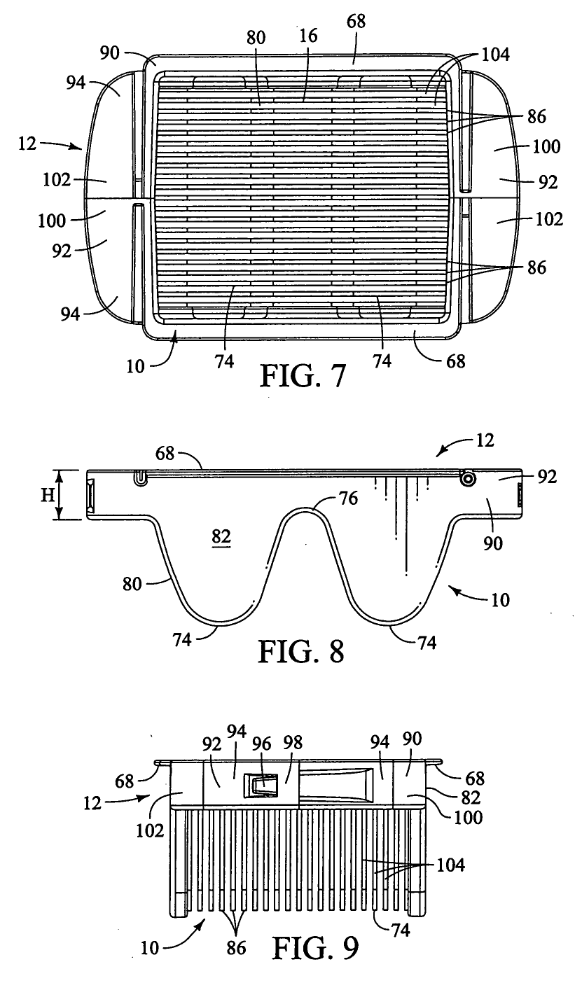

FIG. 7 is a top plan view of the present trap cup and wave screen;

FIG. 8 is a front view of the trap cup and wave screen of FIG. 7;

FIG. 9 is a side view of the trap cup and wave screen of FIG. 7 and

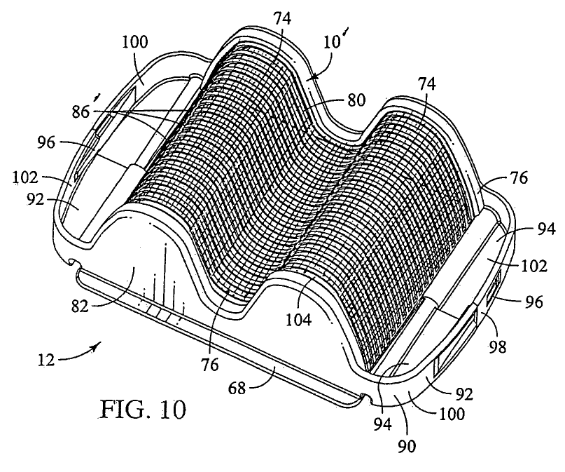

FIG. 10 is a bottom perspective view of an alternate embodiment of the present trap cup having a mesh screen.

### DETAILED DESCRIPTION OF THE INVENTION

Referring to FIGS. 1, 2 and 3, a wave screen, generally designated 10, is fitted to a trap cup, generally designated 12, that is releasably attached to an insect trap, generally designated 14, that utilizes suction to immobilize insects. A source of suction, such as fan 16 (shown hidden in FIG. 3), draws an inflow of air 20 and insects into the insect trap 14 at a suction inlet 22 between a cover 24 and a trap head 26. The air inflow 20 travels through the interior of the trap head 26, past the fan 16. Exhaust air 28 from the fan 16 is blown through an exhaust opening 30 in a bottom or lower end 31 of the trap head 26 and through the trap cup 12 which substantially closes the opening 30. All of the exhaust air exits through the wave screen 10, which acts as a sieve to catch the insects, but allows the air to freely flow through it. The suction-type insect trap 14 is but one embodiment of a trap that effectively utilizes the wave screen 10, and it is exemplified in the following discussion. However, it is contemplated that the wave screen 10 is useful with other types of insect traps. Unless otherwise noted, directional references contained herein are intended to refer to the insect trap 14 or the trap cup 12 when oriented as shown in FIGS. 1 and 2.

The present insect trap 14 burns propane fuel 32 supplied by a fuel line 34 from a fuel tank 36 (both shown in phantom) to generate combustion products and to provide heat to a thermoelectric generator (not shown) that powers electrical devices, such as the fan 16 and or a light 40 (FIG. 1) that indicates when the unit is operating. The inlet air 20 and the fuel 32 are mixed in a combustion chamber (not shown) where they are burned to produce combustion products 42, including carbon dioxide, water vapor and heat. These combustion gases 42 exit the insect trap 14 in a location to which the insects are intended to be attracted. The combustion gases 42 are either combined with the exhaust air 28 and sent through the wave screen 10, or they exit through one or more separate outlets 44. The thermoelectric generator, which generates electricity from the temperature differential across junctions utilizing the Seebeck effect, is well known in the art. In the alternative, electrical power can be obtained directly from household current.

The insect trap 14 is preferably mounted to a cart, generally designated 46 (FIG. 1), so that it may be conveniently moved from place to place. Typically, the cart 46 includes a frame 50, a generally vertically projecting post 52 upon which the insect trap 14 is mounted, a handle 54, a ring or support 56 for the fuel tank, an axle 58 with one or more wheels 60 and one or more feet 62. The cart 46 is shown as one type of supporting for the insect trap 14, but is not important to the function of the wave screen 10. It is contemplated that other insect traps are adaptable for use with the present wave screen 10.

As seen in FIGS. 3 and 4, the trap cup 12 including the wave screen 10 is releasably mounted to the bottom 31 of a trap head housing 66 forming an exterior of the trap head 26. However, the trap cup 10 is mountable to any portion of the insect trap 14 where it is in a position to receive the suction air 20 and entrained insects before they exit the insect trap 14. Preferably, the trap cup 12 is located for the convenience of the user when emptying, or when checking the trap cup to determine if it needs to be emptied.

Any fastening technology for releasably mounting the wave screen 10 or trap cup 12 to the trap head 26 is suitable. Seen best in FIGS. 3 and 4, one preferred mounting system includes a lip 68 on the trap cup 12 that is supported by one or more channels or brackets 70 on the trap head 26. Each of the channels 70 is optionally “L” or “C” shaped and is preferably formed as an integral part of the trap housing 66. As an alternative, the channes 70 are made separately and attached to the trap housing 66 by any suitable fastener. The lips 68 are preferably located on opposing sides of the trap cup 12, and are preferably a simple protrusion from each side of the trap cup. On the trap housing 66, the preferably two channels 70 are positioned in spaced, generally parallel arrangement to receive the lips 68, supporting the trap cup 12 between them. To remove the trap cup 12, the user need only grasp the trap cup 12 and slide it in a direction parallel to the channels 70. The exact shape of the lips 68 and the channels 70 are not important, only that they matingly engage to allow the trap cup 12 to be releasably attached to the trap housing 66.

Other means for attaching the trap cup 12 to the trap housing 66 are equally useful. The trap cup 12 could be attached using a press fit or friction fit closure, magnetic attraction, a lock or latch, a hinge, any type of fastener including pins, hooks or hook and loop fasteners. Attachment of the trap cup 12 is optionally facilitated by sliding the trap cup, twisting it, turning it, rotating it or squeezing it. Any structure for attaching the trap cup 12 to the trap housing 66 is suitable that permits the trap cup 12 to easily be emptied of insects.

As shown in FIGS. 5 and 6, the wave screen 10 includes at least one trough 74 and at least one crest 76 forming at least one wave 80. It is important to have a continuously sloping shape to the wave 80 so that the insects slide down into the trough 74 and air continues to flow through the wave crest 76. Regardless of where the insect intersects the wave screen 10, in the orientation shown in FIG. 1, gravity will put it downward so that over time, a mound of insects collects in the bottom of the trough 74. Compared to a flat bottom trap cup, a relatively large number of insects can be collected without noticeably inhibiting airflow through the wave screen 10. Formation of a mound of insects also reassures the user that the trap 14 is working properly and is catching a significant number of insects.

Although the wave screen 10 is optimally shown as being positioned on the bottom of a preferably rectangular, square or otherwise polygonal trap cup 12, the precise shape of the trap cup is not critical and could also be cylindrical. It is also contemplated that the amplitude of the wave 80 could project in any direction, besides the generally vertical one shown. If the portion of the wave 80 extends laterally outward from the center of the trap cup 12, the trough 74, the crest 76 of the wave 80 would extends inwardly toward the trap cup 12 center. In that orientation, after the insects fill the bottom of the trap cup 12, the airflow will exit through sidewalls 82 of the trap cup 12. Insects will tend to accumulate at the sidewall 82 and be pushed toward the troughs 74, leaving the crests 76 open to airflow. Although not as effective as when the wave screen 10 is on the bottom of the trap cup 12, the use of waves 80 around the sidewall 82 of the trap cup 12 will improve airflow through it. As shown, the sidewalls 82 are solid, however, the use of sidewalls through which air flows is contemplated, provided that the trapped insects are still retained.

A further advantage of piling up the insects at the bottom of the trough 74 is that it encourages natural decomposition of the insect remains. Continuous flow of air over the insects dehydrates them, leaving the remains dry and brittle. When the insects form a mound, the weight of the mound on the remains at the bottom of the trap causes the remains to disintegrate quickly and fall through the tiny openings in the wave screen 10.

The wave screen 10 can be made from any material that will maintain openings of an appropriate size to both trap insects and encourage airflow. Preferred materials are those that hold up in the outdoors, such as polymers or plastics, including, but not limited to polyethylene, polypropylene, polyimides, nylon, poly(methyl methacrylates), acrylics, acetates and polycarbonates. Metal mesh screens are suitable in the wave screen 10, particularly those that are not susceptible to rust, such as aluminum or stainless steel. Fabric mesh sieves are also useful in the wave screen 10, particularly those made of synthetics, such as nylon mesh screens. If the fabric is soft and pliable, supports (not shown) may be needed to hold the fabric in the wave 80 shape.

As shown in FIGS. 7, 8 and 9, the wave screen 10 preferably is formed from a number of rigid, parallel elements 86 in the shape of “W” shaped plastic slats. The screen 10 wave sieve can be made of a mesh where the parallel sieve elements 86 are cross-linked; however, the parallel elements are useful alone if they are rigid enough to screen the insects. Cross-linked sieve elements 86′ in the form of a mesh screen are shown in the alternate embodiment 10′ shown in FIG. 10. Other embodiments of the wave screen 10 that are contemplated include a perforated plate, plastic or aluminum mesh screens, or any screen or sieve that separates insects from the intake air.

The sidewalls 82 and lip 68 are part of a trap cup frame 90 that also includes an endwall 92. It is contemplated that the cup frame 90 and the wave screen 10 can be a single, unitary trap cup 12, or that the wave screen 10 and trap frame 90 can be at least two separate pieces. Wave screen 10 is attachable as a unit to the trap cup frame 90 by suitable mans, including adhesives, fasteners, sand______ the screen between frame pieces and the like. Utilizing a separate wave screen 10 facilitates its removal and replacement if desired, such as if the wave screen 10 should become damaged. However, in the preferred embodiment shown, the trap cup 12 is made of a plurality of sections 94 that include elements of both the trap cup frame 90 and the wave screen 10. The sections 94 are optionally releasably attached or permanently attached to each other. Preferably, each of the sections 94 is identical to each of the other sections for ease in manufacturing and assembly. In the embodiment shown, the trap cup 12 is formed of two sections 94, preferably identical, that releasably attach to each other by means of a spring latch 96 and a catch 98. Each endwall 92 is constructed from a latch end 100 of one section 94 releasably connected to the catch end 102 of another section 94.

Insects are removed from the suction air by the wave screen 10. The overall properties of the wave screen 10 will depend on the insects targeted to be caught and the volume of insects to be accommodated. Openings 104 in the wave screen 10 must be sufficiently small that the insects of interest cannot pass through it, but large enough to facilitate air through the wave screen 10. Thus, if the insect trap 14 is targeting gnats or no-see-ums, the wave screen 10 will be finer than if mosquitoes or flies are the intended target insects. The total surface area of the wave screen 10 is adjustable to provide sufficient air flow through the wave screen for a particular insect capacity. Preferably, the wave screen 10 is located at the exhaust opening 30, substantially closing the opening to insects but allowing the air to exit from the insect trap 14.

Varying the shape of the waves 80 in the wave screen 10 also changes airflow dynamics. When deeper waves 80 are used, the sides of the waves are steeper and the insects tend to pile in a more compact mound. The increase in vertical space is usable for increased airflow, since more open surface area is available at the wave crest 76 for the air to exit the wave trap. Although the crests 76 and troughs 78 are shown as being of uniform shape, it is contemplated that they could vary in any useful manner. For example, FIG. 8 shows two troughs 78 of uniform shape, but it is acceptable to have one trough 78 be deeper than another or have a different radius of curvature. The center crest 76 need not reach the level of the bottom of the trap cup 12, or it can extend upwards past the top of the trap cup and into the trap head 26 itself. Any configuration of shapes of the crests 76 and troughs 78 can be used that supplies sufficient storage space for insects and airflow through the crests.

Best shown in FIG. 8, although the wave screen 10 is shown and described as part of a trap cup 12 having a height H, it is contemplated that H could be negligible and that the wave screen 10 be releasably secured directly to the trap head 26. Where the wave screen 10 provides sufficient storage space for insects in the troughs 78 and permits airflow through the crests 76 without excessive air pressure, there is no need for the sidewalls 82. Preferably the wave screen 10 has enough of a frame 90 to assist the wave screen 10 to hold its shape, however, even the frame is optional where the wave screen 10 is designed to hold insects and be releasably attached to the insect trap 14 on its own. Other features of the trap cup 12, such as the manner in which ways it is releasably attached to the trap head 26, are then directly applicable to the wave screen 10.

In operation, the wave screen 10 and the associated trap cup 12 are attached to the insect trap 14 and the trap is started up. Suction from the fan draws inlet air 20 and entrained insects into the trap head 26 through an inlet 22. Before exiting the trap head 26, the air is screened or filtered to remove the insects, and the air 20 is exhausted to the environment. As the insects are caught by the wave screen 10, they slide down the smooth surface of the wave 80 and form a mound in the trough 74. Air exhausts through the crest 76 of the wave 80 even when the troughs 74 are blocked with insects. Periodically, the wave screen 10 is emptied to remove insect debris from the insect trap 14 by detaching the wave screen 10, pouring the insect debris from the trap cup 12 and replacing the trap cup 12.

While specific embodiments of the wave-shaped insect trap of the present invention have been shown and described for an insect trap, these embodiments describe the best mode of practicing the invention as it is now known. It is not intended to limit the invention, and a number of other possible frame or holder designed are contemplated. It will be appreciated by those skilled in the art that changes and modifications may be made thereto without departing from the invention in its broader aspects and as set forth in the following claims.

1. A wave screen for use with an insect trap comprising a wave-shaped screen to screen insects having at least one trough and at least one crest, said screen being configured to hold insects in said at least one trough and exhaust air through said at least one crest.

2. The wave screen of claim 1 wherein said wave screen comprises at least one of a screen, a mesh fabric, a perforated plate or plurality of rigid, parallel elements spaced sufficiently closely to catch and hold insects.

3. The wave screen of claim 1 wherein said wave screen is releasably attachable to the insect trap.

4. An insect trap apparatus, comprising:
a trap housing having at least one inlet and at least one outlet;
a source of suction associated with said housing and being configured for drawing air and insects through said inlet and exhausting air from said outlet; and
at least one wave screen associated with said housing and being configured for screening insects from the air, said wave screen including at least one trough and at least one crest, said screen being configured to hold insects in said at least one trough and exhaust air through said at least one crest.

5. The apparatus of claim 4 wherein said at least one wave screen is releasably attachable to said housing.

6. The apparatus of claim 4 further comprising a trap cup, and wherein said trap cup includes said wave screen.

7. The apparatus of claim 6 wherein said at least one trap cup has at least one lip that is slidingly engageable with said housing.

8. The apparatus of claim 4 wherein said trap cup is configured to at least substantially close said outlet.

9. The apparatus of claim 4 wherein said wave screen comprises at least one of a mesh screen, a mesh fabric, a perforated plate and a plurality of parallel elements.

10. The apparatus of claim 4 wherein said trap housing further comprises one or more outlets for carbon dioxide.

11. The apparatus of claim 6 wherein said trap cup further comprises two identical sections releasably attached to each other.

12. The apparatus of claim 4 wherein said wave screen includes at least two troughs.

13. A trap cup for an insect trap comprising:
a wave screen comprising a screen configured for screening insects and having a wave shape with at least one trough and at least one crest;
a trap cup frame configured for supporting said wave screen in the wave shape; and
a means for releasably attaching said trap cup to the insect trap.

14. The trap cup of claim 13 wherein said wave screen comprises at least one of a mesh screen, a mesh fabric, a perforated plate and a plurality of parallel elements.

15. The trap cup of claim 13 wherein said means for releasably attaching said housing comprises a lip on said housing that engages a channel on the insect trap.

16. The trap cup of claim 13 wherein said trap cup comprises two identical sections releasably attached to each other.

17. A method of catching insects comprising:
providing an insect trap;
drawing air and insects into the trap;
filtering insects from the air with a wave-shaped screen;
collecting trapped insects in troughs in the wave-shaped screen; and
exhausting air through crests in the wave-shaped screen.

18. The method of claim 17, further comprising emptying the wave-shaped screen of insects by detaching the wave screen, pouring the insects from the trough and re-attaching the wave screen to the insect trap.

19. The method of claim 17, further comprising releasably attaching the wave-shaped screen to the insect trap prior to said drawing step.

20. The method of claim 17, wherein the screen is part of a trap cup and the insect trap includes a channel, and wherein said attaching step comprises sliding the trap cup to engage the channel.

21. The method of claim 17, further comprising attracting insects to the trap with carbon dioxide.
